(19) United States
(12) Patent Application Publication
(10) Pub. No.: US 2002/0084605 A1
(43) Pub. Date: Jul. 4, 2002

(54) Skateboard with a handlebar

(76) Inventor: Ming-Jung Lu, Chiayi City (TW)

Correspondence Address: Rosenberg, Klein & Lee, 3458 Ellicott Center Drive-Suite 101, Ellicott City, MD, 21043, US

(21) Appl. No.: 09/753,623

(22) Filed: Jan. 4, 2001

(51) Int. Cl. B62B 13/00; B62B 9/04; B62B 15/00; B62B 17/00; B62B 19/00; B62M 27/00; B62M 29/00

(52) U.S. Cl. 280/14.28

(57) ABSTRACT

A skateboard with a handlebar has a board member connected to a support rod from a front end. The handlebar is connected to a top end of the support rod for permitting direction of the skateboard to be changed. A front blade is pivoted to a lower end of the support rod, and a rear blade is pivoted to a rear lower part of the board member for permitting the skateboard to be moved along on ice. The blades can be replaced with shaped skis for permitting the skateboard to be moved along on snow. The skateboard further has a brake depressable to move the rear blade downwards for a stopping block on a bottom of the rear blade to contact the ice. The skis have stopping trenches on a bottom; the trenches do not touch the ground normally, but do when the skateboard leans sideways.

### BACKGROUND OF THE INVENTION

The present invention relates to a skateboard with a handlebar particularly to one which can be adapted to slide along on snow.

A conventional skateboard includes a board member, a front wheel, a rear wheel, a support rod, and a handlebar. The support rod can be lengthened and shortened, and is pivoted to a front end portion of the board member by means of a toggle member. The handlebar is connected to a top end of the support rod. The front wheel is connected to a lower end of the support rod. The rear wheel is fitted to a rear end portion of a bottom side of the board members.

Thus, the skateboard with a handlebar can be moved along on the ground by a ride standing on the board member with one foot. And, the direction of the skateboard can be changed by means of moving the handlebar.

However, the skateboard with a handlebar can only be used on a ground, having a very limited use.

### SUMMARY OF THE INVENTION

Therefore, it is a main object of the present invention to provide a skateboard with a handlebar which can be used on ice.

Moreover, it is another object of the present invention to provide a skateboard with a handlebar which can be adapted to slide on snow.

The skateboard with a handlebar of the present invention includes a board member, a toggle member, a support rod, a handlebar, and a pair of blades.

The toggle member is connected to a front end portion of the board member. The support rod is pivoted to the toggle member with the handlebar connected to a top end.

The blades are pivoted to a lower end of the support rod and a rear end portion of the board member respectively such that the skateboard can be moved along on ice.

The skateboard can be provided with skis instead of the blades such that it can be moved along on snow. The skis each has a curved shape, and stopping trenches on two lateral sides of a bottom; the trenches do not touch the ground normally, but do when the skateboard leans sideways.

### BRIEF DESCRIPTION OF THE DRAWINGS

This invention will be better understood by referring to the accompanying drawings, wherein:

FIG. 1 is a perspective view of a skateboard with a handlebar, and usable on ice of the present invention.

FIG. 2 is fragmentary perspective view of the skateboard with a handlebar in FIG. 1.

FIG. 3 is a perspective view of a ski usable on the skateboard with a handlebar of the present invention.

FIG. 4 is a cross-sectional view of the ski in FIG. 3.

### DETAILED DESCRIPTION OF THE PREFERRED EMBODIMENTS

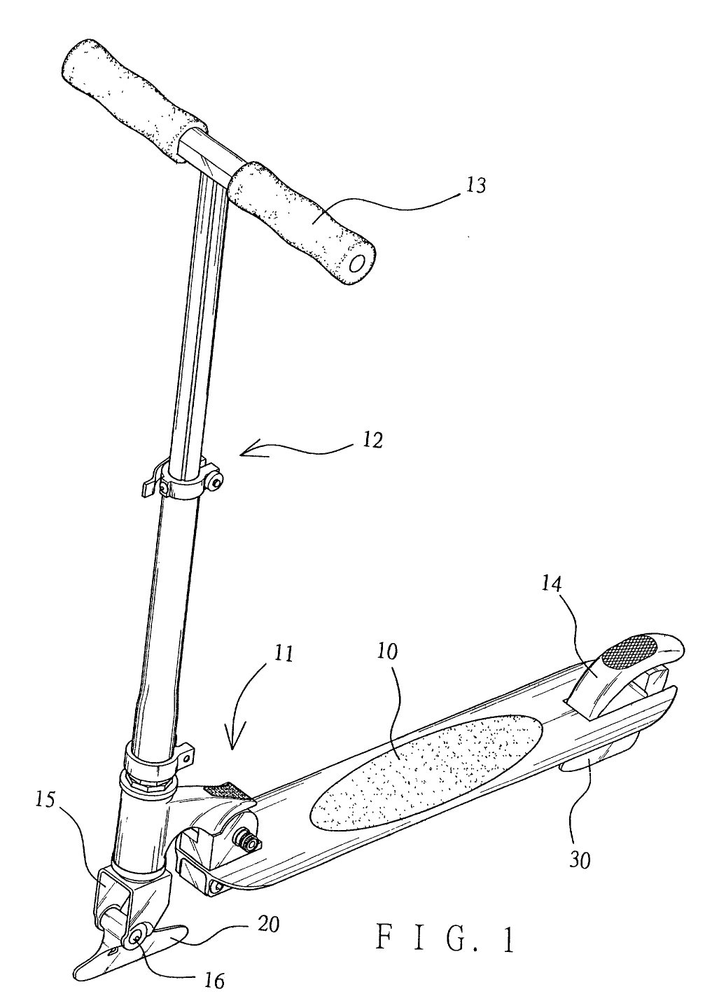

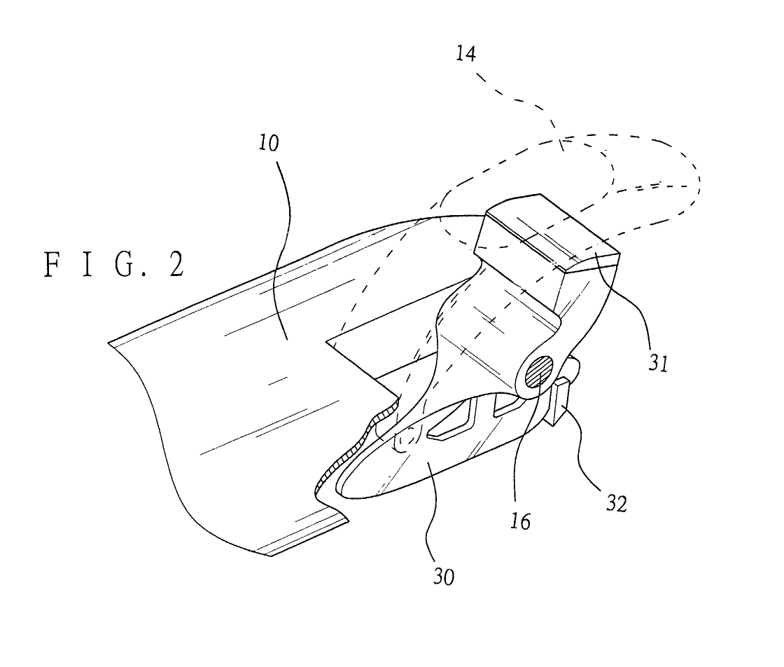

Referring to FIG. 1 and 2, a skateboard with a handlebar of the present invention includes a board member 10, a toggle member 11, a support rod 12, a handlebar 13, a brake 14, a front blade 20, and a rear blade 30. The toggle member 11 is connected to a front end portion of the board member 10. The support rod 12 can be lengthened and shortened, and is pivoted to the toggle member 11 such that the support rod 12 can be moved close to the board member 10 for permitting the skateboard to be folded into a smaller size when not in use.

The handlebar 13 is connected to a top end of the support rod 12. The brake 14 is fitted to a rear end portion of the board member 10.

An inverted-U shaped supporting member 15 is connected to a lower end of the support rod 12.

The front blade 20 is pivoted to the inverted-U shaped supporting member 15 by means of a bolt 16. And, the rear blade 30 is pivoted to a rear bottom side of the board member 10. Thus, the skateboard can be moved along on ice by a rider holding the handlebar 13 with his hands, and stand on the board member 10 with one of his feet. The direction of the skateboard can be changed by moving the handlebar 13.

Referring specifically to FIG. 2, the rear blade 30 further has a contacting block 31 projecting on a top side, and a stopping block 32 on a lower side of a rear end portion; the contacting block 31 is disposed under the brake 14. Thus, when the rider depress the brake 14 with one of his feet, the brake 14 will contact the contacting block 31, and move the stopping block 32 downwards for permitting the stopping block 32 to contact the ice to stop the skateboard.

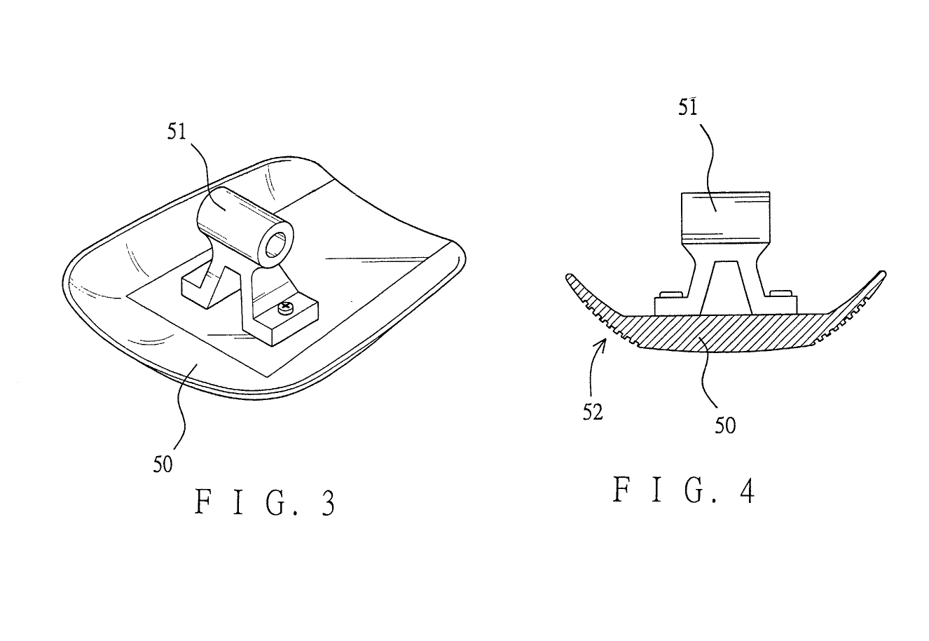

Referring to FIG. 3 and 4, the blades 20 and 30 of the skateboard are each replaced with a ski 50. The ski 50 each has a shaped board potion (not numbered) substantially having a curved cross-section and a connecting part 51 pivoted to the skateboard by means of bolts. The skis 50 each further has trenches 52 on two lateral sides of the bottom portion; when the rider wants to stop the skateboard, he makes the skateboard lean sideways for the trenches 52 of the shaped board portion of the skis 50 to contact the snow; thus, the skateboard can be stopped.

From the above description, the skateboard with a handlebar of the present invention can be known to have desirable features as follows:

1. The skateboard, when provided with blades, can be used on ice, and can be well controlled by means of the handlebar and the brake.

2. The blades can be easily replaced with skis for permitting the skateboard to be used on snow.

What is claimed is:

1. A skateboard comprising
a board member provided for a rider to stand thereon,
a toggle member connected to front end of said board member,
a support rod pivoted to said toggle member; said support rod being connected to a handlebar from a top end and an supporting member from a lower end; and characterized by
a pair of skis pivoted to said supporting member and a rear end portion of said board member respectively for permitting said skateboard to be moved along on snow.

2. The skateboard as claimed in claim 1, wherein said skis are each shaped to have a curved cross-section, and each has trenches on two lateral sides of a bottom part for permitting said trenches to contact said snow by making said skateboard lean sideways in order to stop said skateboard.

3. The skateboard as claimed in claim 1, wherein said skis are replaced with blades pivoted to said supporting member and said rear end portion of said board member respectively for permitting said skateboard to be moved along on ice; a brake being fitted to a rear part of said board member depressable to contact an upper side contacting block of a rear one of said blades in order to move a rear lower stopping block of said rear blade downwards to contact said ice for stopping said skateboard.
